(19) United States
(12) Patent Application Publication
(10) Pub. No.: US 2007/0038629 A1
(43) Pub. Date: Feb. 15, 2007

(54) Resource allocation method, communication system, network element, module, computer program product and computer program distribution medium

(75) Inventors: Phan van Vinh, Kaapelitie (FI); Henrik Liljestrom, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/477,763

(22) Filed: Jun. 30, 2006

(30) Foreign Application Priority Data
Jun. 30, 2005 (FI) 20055370

(51) Int. Cl. G06F 17/30; G06F 7/00

(52) U.S. Cl. 707/9

(57) ABSTRACT

The invention is related to a network element, comprising: means for receiving an upper limit of a network resource, means for determining a user device-specific upper limit for another or same network resource taking into account the upper limit; and means for allocating internal resources of the network element to a predetermined user according to the user device-specific upper limit.

### FIELD OF INVENTION

The invention relates to a resource allocation method, a communication system, a network element, a module, a computer program product and a computer program distribution medium.

### BACKGROUND OF THE INVENTION

A concept of Enhanced Dedicated Channel (E-DCH) or High-Speed Uplink Packet Access (HSUPA) is designed for enhancing uplink packet access in Universal Mobile Telecommunications System (UMTS) terrestrial radio access (UTRA) frequency division duplex (FDD) using dedicated transport channels. A technical objective is to improve the performance of uplink dedicated transport channels, i.e. to increase capacity and throughput and reduce delay by using Node-B controlled fast scheduling and adaptive transmissions or retransmissions.

While applying E-DCH in practice, a radio network controller allocates HSUPA cell resources to base stations (a base station is also called node B). The E-DCH operation, however, has to be adjusted to the capacity and capabilities of base stations of the communication system. Base stations have to reserve dedicated resources for E-DCH related processing, including E-DCH physical channels, Medium Access Control for E-DCH (MAC-e), E-DCH Frame Protocol (FP) and transport bearers.

### SUMMARY OF THE INVENTION

According to an aspect of the invention, there is provided a resource allocation method in a communication system, the method comprising: determining an upper limit for a network resource; signalling the upper limit to a unit determining a user device-specific upper limit for another or same network resource; determining the user device-specific upper limit for the network resource taking into account the upper limit; and allocating resources of the unit to a predetermined user according to the user device-specific upper limit.

According to another aspect of the invention, there is provided a communication system comprising: means for determining an upper limit for a network resource; means for signalling the upper limit to a unit determining a user device-specific upper limit for another or same network resource; means for determining the user device-specific upper limit for the network resource taking into account the upper limit; and means for allocating resources of the unit to a predetermined user according to the user device-specific upper limit.

According to another aspect of the invention, there is provided a network element, comprising: means for receiving an upper limit of a network resource, the upper limit being determined by another network element or a module; means for determining a user device-specific upper limit for another or same network resource taking into account the upper limit; and means for allocating internal resources of the network element to a predetermined user according to the user device-specific upper limit.

According to another aspect of the invention, there is provided a network element comprising: means for receiving an upper limit set for a network resource; means for determining a user device-specific upper limit for another or same network resource taking into account the upper limit; and means for allocating internal resources of the network element to a predetermined user according to the user device-specific upper limit.

According to another aspect of the invention, there is provided a module comprising: means for receiving an upper limit of a network resource, the upper limit being determined by another module or a network element; means for determining a user device-specific upper limit for another or same network resource taking into account the upper limit; and means for allocating internal resources of the module to a predetermined user according to the user device-specific upper limit.

According to another aspect of the invention, there is provided a module comprising: means for receiving an upper limit set for a network resource; means for determining a user device-specific upper limit for another or same network resource taking into account the upper limit; and means for allocating internal resources of the module to a predetermined user according to the user device-specific upper limit.

According to another aspect of the invention, there is provided a computer program distribution medium readable by a computer and encoding a computer program of instructions for executing a computer process for resource allocation, the process comprising: receiving an upper limit set for a network resource; determining a user device-specific upper limit for another or same network resource taking into account the upper limit; and allocating internal resources of a network unit to a predetermined user according to the user device-specific upper limit.

According to another aspect of the invention, there is provided a computer program product encoding a computer program of instructions for executing a computer process for resource allocation, the process comprising: receiving an upper limit set for a network resource; determining a user device-specific upper limit for another or same network resource taking into account the upper limit; and allocating internal resources of a network unit to a predetermined user according to the user device-specific upper limit.

The invention provides several advantages.

An embodiment of the invention provides means for reserving resources, especially hardware and/or software resources, in a base station for E-DCH transmissions. Additionally, the reservation of resources offers a potential to use resources in an efficient and economical way. If the scheduling decisions are not taken into consideration, resources have to be reserved according to peak data rates of the user devices, which is uneconomical as far as resource utilization is concerned.

### BRIEF DESCRIPTION OF THE DRAWINGS

In the following, the invention will be described in greater detail with reference to the embodiments and the accompanying drawings, in which

FIG. 1 shows an example of a communication system;

FIG. 2 is a flow chart;

FIG. 3 illustrates an example of using a pointer;

FIG. 4 illustrates an example of a network element; and

FIG. 5 illustrates another example of a network element.

### DETAILED DESCRIPTION OF THE INVENTION

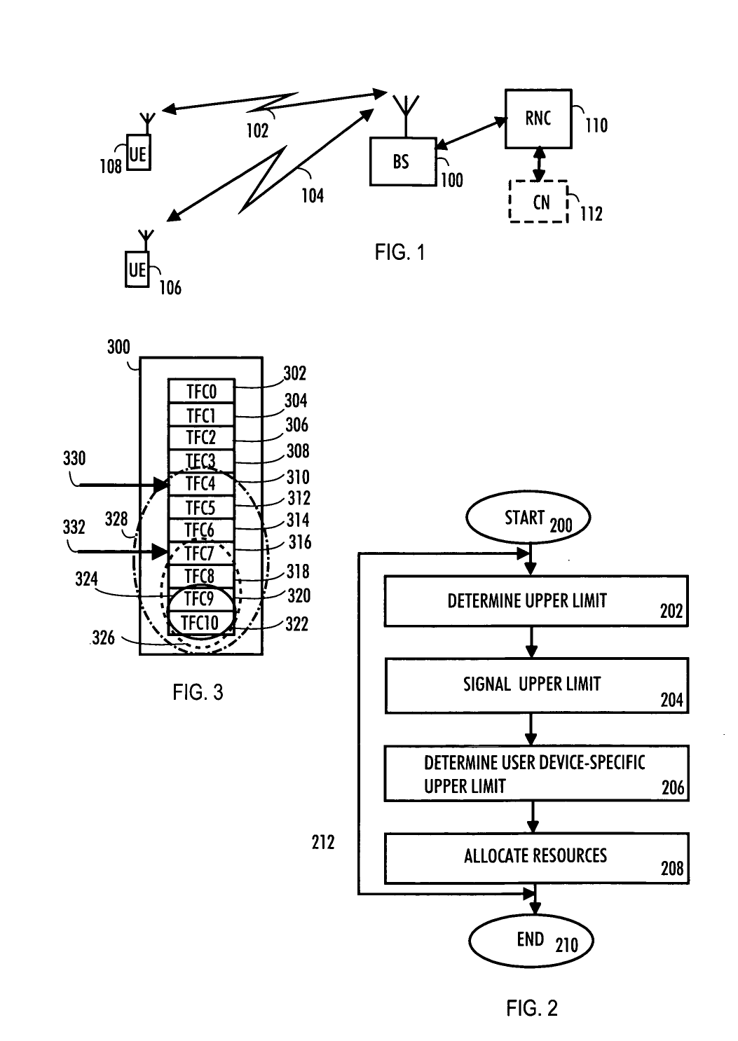

With reference to FIG. 1, we examine an example of a communication system to which embodiments of the invention can be applied. The present invention can be applied to various communication systems, especially to a Universal Mobile Telecommunications System (UMTS) radio access network. It is a radio access network which includes wideband code division multiple access (WCDMA) technology and which can also offer real-time circuit and packet switched services. The embodiments are not, however, restricted to the systems given as examples but a person skilled in the art may apply the solution to other communication systems provided with the necessary properties.

It is clear to a person skilled in the art that the method according to the invention can be applied to systems utilizing different air interface standards. Orthogonal frequency division multiplexing (OFDM) is widely used in wireless local and metropolitan area networks. In Evolved UMTS terrestrial radio access network (UTRAN), the downlink is proposed to be based on OFDM, and for the uplink, various frequency division multiple access (FDMA) methods have been proposed. Any modulation and coding method may be used, such as quadrature phase shift keying (QPSK), as well as any multi-antenna transmission method.

FIG. 1 is a simplified illustration of a data transmission system to which the solution according to the invention is applicable. This is a part of a cellular radio system which comprises a base station (or node B) 100, which has bi-directional radio links 102 and 104 to user devices 106 and 108. The user devices may be fixed, vehicle-mounted or portable. The base station includes transceivers, for instance. From the transceivers of the base station, a connection is provided to an antenna unit that establishes bi-directional radio links to the user devices. The base station is further connected to a controller 110, a radio network controller (RNC) or a base station controller (BSC), which transmits the connections of the devices to the other parts of the network. The base station controller of the radio network controller controls in a centralized manner several base stations connected to it. The base station controller or the radio network controller is further connected to a core network 112 (CN). Depending on the system, the counterpart on the CN side can be a mobile services switching centre (MSC), a media gateway (MGW) or a serving GPRS (general packet radio service) support node (SGSN) etc.

It should be noticed that in future radio networks, the functionality of an RNC or a BSC may be distributed among (possibly a subset of) base stations.

The radio system can also communicate with other networks, such as a public switched telephone network or the Internet.

First, the basics of base station scheduling in the UMTS are explained.

On the downlink, a resource indication, typically Scheduling Grant, is required to indicate to a user device the maximum amount of uplink resources it may use. When issuing Scheduling Grant messages, a base station may use quality of service (QoS) related information provided by a serving radio network controller (SRNC). User devices may also transmit QoS related information with Scheduling Request messages.

Two types of Scheduling Grant messages exist: an Absolute Grant and a Relative Grant message. Absolute Grant messages provide an absolute limit for the maximum amount of uplink resources a user device may use. Relative Grant messages increase or decrease resource limitation compared to a previously used value.

Absolute Grant messages are sent by a serving E-DCH cell. They are valid for one user device, a group of user devices or for all user devices serviced by the same base station. An Absolute Grant message contains the identity (E-DCH radio Network Temporary Identifier, E-RNTI) of a user device (or a group of user devices) to which the grant is intended, the maximum power ratio the user device is allowed to use, and a flag indicating whether the Absolute Grant message is applicable to a single process or to all processes.

In the following, Medium Access Control (MAC) architecture on the UTRAN side is briefly clarified. Medium Access Control is further clarified in 3GPP TS 25.309 specification which is incorporated herein by reference. E-DCH MAC multiplexing is logical channel multiplexing supported by Medium Access Control for an E-DCH (MAC-e) level.

The UTRAN MAC architecture includes a new MAC-e entity and a new MAC-es entity. MAC-es is a MAC-e sub-layer. One MAC-e entity per a base station and one MAC-es entity in a SRNC are configured for each user device using E-DCH. MAC-es is further coupled to MAC-d which is MAC for a normal Dedicated Channel.

In a base station, one MAC-e entity for each user device and one E-DCH scheduler for the base station are usually provided. A MAC-e entity and an E-DCH scheduler handle HSUPA specific functions. MAC-e entity also includes an E-DCH control entity and a Hybrid Automatic repeat Request (HARQ) entity.

The E-DCH scheduler is base station specific and it manages E-DCH cell resources between user devices. The E-DCH scheduler manages scheduling requests and scheduling assignments. An E-DCH control entity is, in turn, responsible for reception of scheduling requests and transmission of scheduling assignments. HARQ-entities are, for instance, responsible for supporting stop and wait HARQ protocols.

In High-Speed Uplink Packet Access (HSUPA), scheduling is carried out in a base station. Hence, the base station is able to control uplink power allocated to user devices. Therefore, in resource allocation, a potential exist to perform mapping between granted power and the maximum data rate a user device is allowed to transmit.

In code division systems, such as WCDMA, the capacity of a network is restricted by interference caused by a user to other users. Interference limitation means power limitation. Thus, network resources (could also be called radio resources or telecom resources), for example a data rate, are limited by the maximum power allowed to a user. In practice, this means that scheduling is carried out taking the maximum power into consideration.

Since resource allocation is carried out by a base station and required signalling is carried out at Open Systems Interconnection Reference Model (OSI model) layer 1 (physical layer), the resource allocation can be dynamic, providing a possibility to dynamically share network resources between user devices.

In embodiments of the resource allocation method presented in this application, different pointers may be used to define base station resources (usually hardware resources) necessary for the base station to be able to receive Enhanced Dedicated Physical Channel (E-DPCH) transmissions from a user device. From resource management's point of view, Enhanced Physical Data Channels (E-DPDCH) are the most important channels. Pointers are usually user (or user device) specific.

In the following, an embodiment of the resource allocation method is explained in further detail by means of FIG. 2. The embodiment provides a resource allocation method that combines network scheduling of available network resources, such as transmit power and data rates, among users with allocation of internal resources of a network element, such as a base station, or a module (hardware and/or software resources). The embodiment enables both dynamic scheduling and dynamic internal resource allocation.

The embodiment starts in block 200.

In block 202, an upper limit for a network resource is determined.

In this application, the concept of a network resource means resources (or services) a communication network provides to a user, such as data rate. Internal or processing resources mean hardware and/or software resources of a unit or a module providing network resources. An example of such a unit is a network element, such as a base station.

In systems supporting E-DCH, typically, an upper limit for a predetermined network resource, such as a data rate, is set. The limit usually corresponds to the maximum capability, for example the maximum transmission data rate of a user device, but it can be lower, for instance, if a network does not support the maximum data rate of a user device. The upper limit may be set by an upper level network element, such as a radio network controller (RNC). Thus, the upper level network element may restrict network resource allocation by setting an upper limit lower than that of the capability of the user device in the particular resource.

Each user device in the system usually has an upper limit of its own. In order to enable a network element to set an upper limit, a user device may signal its maximum capability to the network element.

The upper limit may be user device-specific or, more typically, cell-specific. Usually in the case of a cell-specific upper limit, the upper limit is semi-static, in other words, it is updated only quite rarely.

The upper limit may be marked in a memory by using a first pointer (a node B pointer). An example of a use of pointers is explained below. The function of the first pointer is to indicate a current level (amount) of allocated network element resources, for example, resources reserved in a base station or another unit taking care of operations of a base station. It is obvious to a person skilled in the art that means other than a pointer may also be used for indicating reserved resources.

In block 204, the upper limit is signalled to a unit determining a user device-specific upper limit for another or the same network resource.

The signalling may be provided between a stand-alone upper level network element, such as a radio network controller, and a stand-alone lower level network element, such as a base station (node B). The signalling may also be provided between different modules in the same network element (or in another device taking care of network control), depending on the architecture of the communication system. The modules may also be called an upper level network element and a lower level network element. The signalling may, of course, be carried out wirelessly or by using a wired connection.

Usually in the case of a cell-specific upper limit, the upper limit is semi-static, in other words, it is updated only quite rarely.

In block 206, the user device-specific upper limit is determined for the network resource, taking into account the upper limit.

Typically, the lower level network element or a module carrying out network control may set a new lower value as a maximum for a network resource, such as a data rate, allowed to a user device. In a system supporting E-DCH, a new lower maximum may be set while scheduling is carried out, preferably with Absolute or Relative Grants.

A second maximum limit (the user device-specific upper limit) may be marked in a memory by using a second pointer (a user device pointer). The function of the second pointer is to indicate a current level (amount) of allocated user device resources. It is obvious to a person skilled in the art that means other than a pointer may also be used for indicating reserved resources.

The second pointer typically triggers radio resource management functions in a base station. An example of a use of pointers is explained below.

The lower level network element may signal the new upper limit to the upper level network element in order for the upper level network element to be able to track reserved resources in the network. The new upper limit is also signaled to a user device for informing an available data rate, for instance.

In block 208, resources of the unit are allocated to a predetermined user (or user device) according to the user device-specific upper limit.

Resources which are typically allocated include hardware and/or software resources, such as processor time or, if a plurality of processors is available, allocation may be processor allocation. These resources may be called internal or processing resources. The amount and type of hardware and/or software resources usually determine the type and amount of network resources a network can provide; for example, enough resources have to be reserved in network elements in order to enable them offer an adequate data rate or quality of service.

Telecom or radio resource management may be applied to E-DCH reception simultaneously with the first set up. In order to save in interprocessor data transferring or in data transfer between other hardware resource units, it is beneficial to process E-DCH signals by using as few hardware resource units, such as cards or processors, as possible. To avoid transferring E-DCH users between different hardware resource units, E-DCH users may be controlled virtually by performing a group thereof locating in one hardware resource unit.

Typically, telecom or radio resource management directs EDCH users to use hardware resources. It is also important to monitor an active or inactive status of E-DCH users. Therefore, software controlling the use of resources may be a part of telecom or radio resource management.

In some cases, the user device-specific upper limit is also a minimum value for hardware resources a network has to provide. On the other had, the user device-specific upper limit may, of course, also be the same as the limit set by an upper level network element (the upper limit). The upper level network element may also set an upper limit to be so low that a user device is only allowed to use the minimum of available resources.

There may be a plurality of resources to be allocated. The number of simultaneous E-DCH users, capacities and capabilities of base stations (or node Bs) also affect the resource allocation.

The embodiment ends in block 210. Arrow 212 depicts one possibility for repeating the method.

It should be noticed that an upper limit may be determined for a network resource other than the user device-specific upper limit; for example, an upper level network element determines a maximum, that is an upper limit, for total power in the system and the lower level network element determines a maximum, that is a user device-specific upper limit, for a data rate based on the maximum power (i.e. an upper limit).

Next, an example of pointers used in resource allocation is explained in further detail by means of FIG. 3.

User-specific pointers as shown by means of FIG. 3 are constricted by the capacity of the lower level network element or a corresponding device and adapted according to scheduled network resources of a user. The pointers may be simultaneously used for indicating the level of network resources that are schedulable to users.

The pointers are implemented in such a way that they support dynamic scheduling among users by being able to be swapped from one user to another according to determination of corresponding upper limits. A pointer points to a network element, such as a base station, communication context or a profile that in turn defines allocated resources necessary for processing a corresponding channel, for example E-DCH, in the network element.

FIG. 3 shows an example of a set of transport format combinations (TFC) 300. Transport format combinations are marked with reference numbers 302 to 322. A transport format combination contains one transport format from each transport channel. The transport format combination set 300 is a maximum set representing the maximum capability of a user device, such as a maximum data rate a user device is able to use in transmission, or the maximum capability of a network.

An upper level network element, such as a radio network controller, may configure a transport format combination subset which provides a user device with less network resources than the maximum set. One example of a subset is marked in FIG. 3 with reference number 328. Subset 328 gives a base station a range for a base station to within which to operate.

A transport format combinations subset 326 is the network resource subset currently allocated to a user device by a base station. The network resources of subset 326 are controlled by a user device.

The upper limit 330 defining a transport format combination subset controlled by a base station may be marked in a memory by using a first pointer (a node B pointer).

Upper limit 332 defining a transport format combination subset controlled by a user device may be marked in a memory by using a second pointer (a user device pointer).

TFC9 320 and TFC10 322 perform a network resource subset called a minimum set 324. The minimum set means that a network has to provide a user device with at least these network resources. The network resources of a minimum set may be separately selected for every user by an operator, for example. The minimum set may be the same to all users or it may vary, for instance, according to a customer profile: customers having a cheaper connection may have less network resources in a minimum set than customers having a more expensive connection.

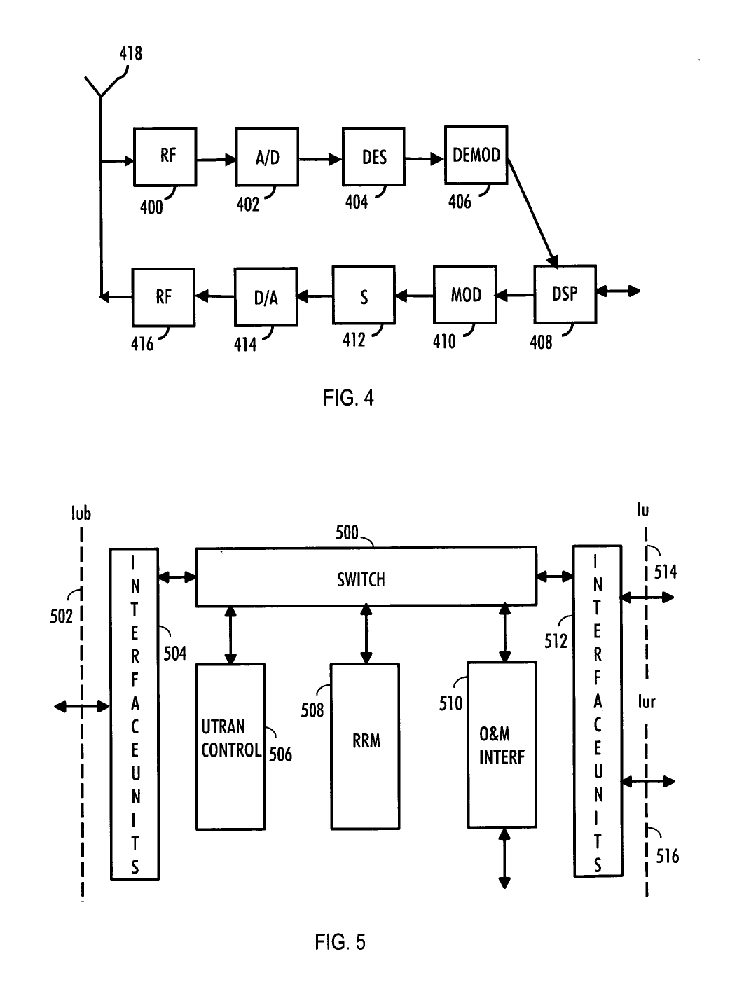

FIG. 4 illustrates a simplified exemplary embodiment of a lower level network element in relation to the functionalities required by the allocation method described above. It is obvious to a person skilled in the art that the network element can deviate from what is depicted in FIG. 4. The implementation of different modulation methods may change the structure of a transmitter and a receiver, for example. The network element illustrated in Figure 4 is a base station (or node B). The precise implementation of the base station is vendor-dependent.

The exemplary lower level network element provides a resource allocation method that combines network scheduling of available network resources, such as transmit power and data rates, among users with allocation of internal resources (hardware and/or software resources) of a network element, such as a base station, or a module.

In FIG. 4, blocks 410 to 416 describe a transmitter and blocks 400 to 406 a receiver. The example of FIG. 4 shows the radio parts of the transmitter and the receiver as separate ones, but they may also be combined.

A signal-processing block 408 describes the hardware parts of the base station required for generating user speech or data in the transmitter. There may be one signal processing block, such as in the example of the figure, or a separate one for the transmitter and the receiver.

Signal processing, which includes channel coding, is usually implemented in a DSP processor 408 (DSP=Digital Signal Processing). The aim of channel coding is to ensure that transmitted information can be restored in a receiver even if not every information bit could be received properly.

In block 410, the signal is modulated using the desired modulation method. Block 412 describes multiplication by a spreading code performed on the information to be transmitted in direct sequence spread spectrum systems and used to spread a narrowband signal into a wideband one. In an embodiment of the invention, the code used in spreading may also be the same as the code indicating the information transfer zone in routing. Modulation and spreading may also be a part of the DSP processor.

The signal is converted from a digital form into an analog one in block 414. In RF parts 416, the signal is up-converted to the selected transmission frequency either directly or via an intermediate frequency, amplified and filtered, if necessary.

In the example of the figure, the transmitter and the receiver share the same antenna 418, whereby a duplex filter is required to separate a signal to be transmitted and received from one another. The antenna may be an individual antenna or an array antenna composed of several antenna elements.

The receiver comprises RF parts 400, where a received signal is filtered, down-converted either directly to base band or to an intermediate frequency, and amplified. In block 402, the signal is converted from analog into digital by sampling and quantizing; in block 404, the direct spread wideband signal is despread by multiplication by a code sequence generated by a code generator; in block 406, the effect of the data modulation is removed by demodulation, and, in block 408, necessary signal processing is performed, such as de-interleaving, decoding and decryption.

Embodiments of the resource allocation method may at least partially be implemented by using a computer program comprising instructions for executing a computer process for receiving an upper limit set for a network resource, determining a user device-specific upper limit for another or same network resource taking into account the upper limit and allocating internal resources of a network unit to a predetermined user device according to the user device-specific upper limit. The network unit may be a network element or a module.

The computer program may be located in Digital Signal Processor 408.

The implementation solution can also be, for instance, an ASIC (Application Specific Integrated Circuit) component. An ASIC is an example of a module. A hybrid of software and hardware implementations is also feasible.

An upper level network element, such as a radio network controller, may determine the upper limit in a similar manner to that used in the prior art. The lower level network element, such as a base station, may determine the user device-specific upper limit in a similar manner to that used in the prior art.

The upper limit may be conveyed as a part of normal signalling between a radio network controller and a base station.

Embodiments are clarified above by means of FIGS. 2 and 3.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Referring to FIG. 5, a simplified block diagram illustrates an example of a logical structure of a radio network controller. A radio network controller is herein taken as an example of an upper level network element. A radio network controller (RNC) is a switching and controlling element of UTRAN. Switching 500 takes care of connections between a core network and user devices, such as a mobile phones. The radio network controller is located between lub 502 and lu 514 interfaces. The network controller in connected to these interfaces via interface units 504, 512. An interface is also provided for inter-RNC transmission and it is called lur 516.

The functionality of the radio network controller can be classified into two classes: UTRAN radio resource management 508 and control functions 506. An operation and management interface function 510 serves as a medium for information transfer to and from network management functions. The radio resource management is a group of algorithms used for sharing and managing a radio path connection so that the quality and capacity of the connection are adequate. Some of the most important radio resource management algorithms include handover control, power control, admission control, packet scheduling, and code management. The UTRAN control functions take care of functions related to the set-up, maintenance and release of a radio connection between base stations and a user device.

The precise implementation of the radio network controller is vendor-dependent.

It should be noticed that the embodiments may not only be carried out in an upper level network element, such as a radio network controller and in a lower level network element, such as a base station (node B), but another option is to use different modules, such as cards, ASICs and processors, taking care of network element tasks in the same network element (or another device taking care of network control), depending on the architecture of a communication system. It is also possible that resource allocation is carried out in one module or element.

Even though the invention has been described above with reference to an example according to the accompanying drawings, it is clear that the invention is not restricted thereto but it can be modified in several ways within the scope of the appended claims.

What is claimed is:

1. A resource allocation method in a communication system, the method comprising:
determining an upper limit for a network resource;
signalling the upper limit to a unit determining a user device-specific upper limit for another or same network resource;
determining the user device-specific upper limit for the network resource taking into account the upper limit; and
allocating resources of the unit to a predetermined user according to the user device-specific upper limit.

2. The method of claim 1, wherein the allocation of the resources of the unit comprises allocating hardware and software resources to receive Enhanced Dedicated Channel (E-DCH) transmissions from a user device.

3. The method of claim 1, further comprising:
setting the user device-specific upper limit for data with Absolute or Relative Grant messages.

4. The method of claim 1, further comprising:
signalling the user device-specific upper limit to an upper level network element using a lower level network element to enable the upper level network element to track reserved resources in the network.

5. The method of claim 1, further comprising:
marking the upper limit in a memory using a first pointer and marking the user device-specific upper limit in the memory by using a second pointer.

6. The method of claim 1, further comprising:
marking the upper limit in a memory using a first pointer and marking the user device-specific upper limit in the memory using a second pointer; and
swapping the first pointer and the second pointer from one user to another according to the determination of the upper limit and the user device-specific upper limit, respectively.

7. A communication system, comprising:
a first determining unit configured to determine an upper limit for a network resource;
a signalling unit configured to signal the upper limit to a unit determining a user device-specific upper limit for another or same network resource;
a second determining unit configured to determine the user device-specific upper limit for the network resource taking into account the upper limit; and
an allocating unit configured to allocate resources of the unit to a predetermined user according to the user device-specific upper limit.

8. The communication system of claim 7, wherein the resource allocation of the unit is allocation of hardware or software resources for receiving Enhanced Dedicated Channel (E-DCH) transmissions from a user device.

9. The communication system of claim 7, further comprising:
a setting unit configured to set the user device-specific upper limit for data with Absolute or Relative Grant messages.

10. The communication system of claim 7, further comprising:
a lower level network element unit configured to signal the user device-specific upper limit to an upper level network element to enable the upper level network element to track reserved resources in the network.

11. The communication system of claim 7, wherein the upper limit is marked in a memory using a first pointer and the user device-specific upper limit is marked in the memory using a second pointer.

12. The communication system of claim 7, wherein the upper limit is marked in a memory using a first pointer and the user device-specific upper limit is marked in the memory using a second pointer, the first pointer and the second pointer being able to be swapped from one user to another according to the determination of the upper limit and the user device-specific upper limit, respectively.

13. A network element, comprising:
a receiver configured to receive an upper limit of a network resource, the upper limit being determined by another network element or a module;
a determining unit configured to determine a user device-specific upper limit for another or same network resource taking into account the upper limit; and
an allocating unit configured to allocate internal resources of the network element to a predetermined user according to the user device-specific upper limit.

14. A network element, comprising:
a receiver configured to receive an upper limit set for a network resource;
a determining unit configured to determine a user device-specific upper limit for another or same network resource taking into account the upper limit; and
an allocating unit configured to allocate internal resources of the network element to a predetermined user according to the user device-specific upper limit.

15. The network element of claim 14, wherein the network element is a base station or node.

16. The network element of claim 14, further comprising:
a carrying out unit configured to carry out resource allocation of hardware and software resources for receiving Enhanced Dedicated Channel (E-DCH) transmissions from a user device.

17. The network element of claim 14, further comprising:
a setting unit configured to set the user device-specific upper limit with Absolute or Relative Grant messages.

18. The network element of claim 14, further comprising:
a signalling unit configured to signal the user device-specific upper limit to the upper level network element to enable the upper level network element to track reserved resources in the network.

19. The network element of claim 14, wherein the upper limit is marked in a memory using a first pointer and the user device-specific upper limit is marked in the memory using a second pointer.

20. The network element of claim 14, wherein the upper limit is marked in a memory using a first pointer and the user device-specific upper limit is marked in the memory using a second pointer, the first pointer and the second pointer being able to be swapped from one user to another according to the determination of the upper limit and the user device-specific upper limit, respectively.

21. A module, comprising:
a receiver configured to receive an upper limit of a network resource, the upper limit being determined by another module or a network element;
a determining unit configured to determine a user device-specific upper limit for another or same network resource taking into account the upper limit; and
an allocating unit configured to allocate internal resources of the module to a predetermined user according to the user device-specific upper limit.

22. A module, comprising:
a receiver configured to receive an upper limit set for a network resource;
a determining unit configured to determine a user device-specific upper limit for another or same network resource taking into account the upper limit; and
an allocating unit configured to allocate internal resources of the module to a predetermined user according to the user device-specific upper limit.

23. The module of claim 22, further comprising:
a carrying out unit configured to carry out resource allocation of hardware or software resources for receiving Enhanced Dedicated Channel (EDCH) transmissions from a user device.

24. The module of claim 22, further comprising:
a setting unit configured to set the user device-specific upper limit with Absolute or Relative Grant messages.

25. The module of claim 22, further comprising:
a signalling unit configured to signal the user device-specific upper limit to the upper level network element or another module to enable the upper level network element or the module to track reserved resources in the network.

26. The module of claim 22, wherein the upper limit is marked in a memory using a first pointer and the user device-specific upper limit is marked in the memory using a second pointer.

27. The module of claim 22, wherein the upper limit is marked in a memory using a first pointer and the user device-specific upper limit is marked in the memory using a second pointer, the first pointer and the second pointer being able to be swapped from one user to another according to the determination of the upper limit and the user device-specific upper limit, respectively.

28. A computer program product encoding a computer program of instructions for executing a computer process for resource allocation, the process comprising:
receiving an upper limit set for a network resource;
determining a user device-specific upper limit for another or same network resource taking into account the upper limit; and
allocating internal resources of a network unit to a predetermined user according to the user device-specific upper limit.

29. A computer program distribution medium readable by a computer and encoding a computer program of instructions for executing a computer process for resource allocation, the process comprising:
receiving an upper limit set for a network resource;
determining a user device-specific upper limit for another or same network resource taking into account the upper limit; and
allocating internal resources of a network unit to a predetermined user according to the user device-specific upper limit.

30. The computer program distribution medium of claim 29, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.

31. A communication system, comprising:
means for determining an upper limit for a network resource;
means for signalling the upper limit to a unit determining a user device-specific upper limit for another or same network resource;
means for determining the user device-specific upper limit for the network resource taking into account the upper limit; and
means for allocating resources of the unit to a predetermined user according to the user device-specific upper limit.

32. A network element, comprising:
means for receiving an upper limit of a network resource, the upper limit being determined by another network element or a module;
means for determining a user device-specific upper limit for another or same network resource taking into account the upper limit; and
means for allocating internal resources of the network element to a predetermined user according to the user device-specific upper limit.

33. A network element, comprising:
means for receiving an upper limit set for a network resource;
means for determining a user device-specific upper limit for another or same network resource taking into account the upper limit; and
means for allocating internal resources of the network element to a predetermined user according to the user device-specific upper limit.

34. A module, comprising:
means for receiving an upper limit of a network resource, the upper limit being determined by another module or a network element;
means for determining a user device-specific upper limit for another or same network resource taking into account the upper limit; and
means for allocating internal resources of the module to a predetermined user according to the user device-specific upper limit.

35. A module, comprising:
means for receiving an upper limit set for a network resource;
means for determining a user device-specific upper limit for another or same network resource taking into account the upper limit; and
means for allocating internal resources of the module to a predetermined user according to the user device-specific upper limit.
